(19) United States
(12) Patent Application Publication
(10) Pub. No.: US 2002/0004732 A1
(43) Pub. Date: Jan. 10, 2002

(54) System and method for coordinating production and distribution of paper products packaged with promotional materials

(76) Inventor: William Donovan Quigg, Hoquiam, WA (US)

Correspondence Address: PERKINS COIE LLP, PATENT-SEA, P.O. BOX 1247, SEATTLE, WA, 98111-1247, US

(21) Appl. No.: 09/849,504

(22) Filed: May 4, 2001

Related U.S. Application Data
(60) Provisional application No. 60/202,583, filed on May 9, 2000.

(51) Int. Cl. G06F 17/60

(52) U.S. Cl. 705/7; 705/14

(57) ABSTRACT

A method and computer system for processing a paper product. The computer system can include a product order tracker configured to receive a paper product order from a paper purchaser to purchase paper product that is produced by a paper manufacturer. The paper product can include a roll of paper or plurality of unbound stacked paper sheets. The system can further include a promotions order tracker configured to receive a promotional material order from a third-party advertiser to place promotional material on an enclosure for the paper product or in the enclosure for the paper product. The system can still further include a paper product tracker configured to provide instructions for creating the enclosure for the paper product. The enclosure can have or enclose the promotional material of the received promotional material order, and the paper product tracker can further be configured to provide instructions to enclose the paper product of the received order with the created enclosure. The paper manufacturer, the paper purchaser, and the third-party advertiser are different entities, and the third-party advertiser pays to have the promotional material placed on or enclosed by the enclosure of the paper product.

### TECHNICAL FIELD

The following relates generally to systems and methods for coordinating production and distribution of paper products, such as reams of paper, packaged with wrappers, cartons or other enclosures bearing promotional materials, such as advertisements and/or coupons.

### BACKGROUND

Conventional promotions, such as advertisements, have been developed for many media. For example, advertisements have been developed for television, radio, print media (such as newspapers and magazines) and billboards. Many of these conventional advertisements suffer from several drawbacks. For example, television, radio, and some print media advertisements can be very expensive. Furthermore, it may be difficult to direct the advertisements to those customers most likely to purchase the goods or services that are the subject of the advertisements. Still further, the length of time the potential customers are exposed to advertisements can be quite short. For example, typical radio and television advertisements are 30-60 seconds long and the typical magazine advertisement may be viewed by the potential customer only briefly as the customer flips the pages of the magazine.

Advertisements are also provided on the Internet, for example, on web pages. The Internet is increasingly being used to conduct “electronic commerce,” in part, because it facilitates electronic communications between vendors and purchasers. The Internet comprises a vast number of computers and computer networks interconnected through communication channels. Electronic commerce refers generally to commercial transactions at least partially conducted using the computer systems of the parties to the transactions. For example, a purchaser can use a personal computer to connect via the Internet to a vendor's computer. The purchaser can then interact with the vendor's computer to conduct the transaction. Although many of the commercial transactions that are performed today could be performed via electronic commerce, the acceptance and wide-spread use of electronic commerce depends, in large part, upon the ease-of-use of conducting such electronic commerce and upon creating new opportunities previously unavailable. For example, if electronic commerce can be easily conducted, then even the novice computer user will choose to engage in electronic commerce. Therefore, it is important that techniques be developed to facilitate conducting electronic commerce.

The Internet facilitates conducting electronic commerce, in part, because it uses standardized techniques for exchanging information. Many standards have been established for exchanging information over the Internet, such as electronic mail, Gopher, and the World Wide Web (“WWW”) The WWW service allows a server computer system (i.e., web server or web site) to send graphical web pages of information to a remote client computer system. The remote client computer system can then display the web pages. Each resource (e.g., computer or web page) of the WWW is uniquely identifiable by a Uniform Resource Locator (“URL”). To view a specific web page, a client computer system specifies the URL for that web page in a request (e.g., a HyperText Transfer Protocol (“HTTP”) request). The request is forwarded to the web server that supports that web page. When that web server receives the request, it sends the requested web page to the client computer system. When the client computer system receives that web page, it typically displays the web page using a browser. A browser is typically a special-purpose application program for requesting and displaying web pages.

Currently, web pages are often defined using HyperText Markup Language (“HTML”). HTML provides a standard set of tags that defines how a web page is to be displayed. When a user makes a request to the browser to display a web page, the browser sends the request to the server computer system to transfer to the client computer system an HTML document that defines the web page. When the requested HTML document is received by the client computer system, the browser displays the web page as defined by the HTML document. The HTML document contains various tags that control the display of text, graphics, controls, and other features. The HTML document may contain URLs of other web pages available on that server computer system or on other server computer systems.

The World Wide Web portion of the Internet is especially conducive to conducting electronic commerce. Many web servers have been developed through which vendors can advertise and sell products. The products can include items (e.g., music) that are delivered electronically to the purchaser over the Internet and items (e.g., books) that are delivered through conventional distribution channels (e.g., a common carrier). A server computer system may provide an electronic version of a catalog that lists the items available. A user, who is a potential purchaser, may browse through the catalog using a browser and select various items to be purchased. When the user has finished selecting the items to be purchased, the server computer system then prompts the user for information to complete the ordering of the items. This purchaser-specific order information may include the purchaser's name, the purchaser's credit card number, and a shipping address for the order. The server computer system then typically confirms the order by sending a confirming web page to the client computer system, and schedules shipment of the items.

The World Wide Web is also being used to unite sellers of goods or services, such as paper products, with purchasers wishing to buy such goods or services. For example, Paperexchange.com provides a web site at http://www.Paperexchange.com by which buyers may enter specific data with respect to a paper product they wish to purchase. The Paperexchange.com web site then makes this data available to selected paper manufacturers. The manufacturer and the buyer can complete a purchase agreement for the paper products, and, in one mode of operation, the buyer is unaware of the seller's identity and the seller is unaware of the buyer's identity.

Although the Internet provides the features described above, advertisements on the Internet may suffer from several drawbacks. For example, users are typically exposed to advertisements provided on Internet web pages for only a brief time, and may view the advertisements as a distraction. Accordingly, it is desirable to provide a more effective form of promotion for products and services.

### BRIEF DESCRIPTION OF THE DRAWINGS

FIG. 1 is a partially schematic diagram illustrating components of a computerized system that coordinates placing promotional materials on or within packaging materials for paper products in accordance with an embodiment of the invention.

FIG. 2 is a block diagram illustrating components of a computer system for coordinating the placement of promotional materials in accordance with an embodiment of the invention.

FIG. 3 is a block diagram illustrating steps performed by a computer system in accordance with an embodiment of the invention.

FIGS. 4A-E illustrate additional steps performed by a computer system in accordance with an embodiment of the invention.

FIG. 5 is a partially schematic plan view of an unfolded wrapper configured to enclose a ream of paper in accordance with an embodiment of the invention.

FIGS. 6A-6C are illustrations of promotional materials on other paper product enclosures in accordance with other embodiments of the invention.

FIG. 7 is a flow diagram of a representative implementation of a process performed with or without the system shown in FIG. 1 in accordance with an embodiment of the invention.

FIG. 8 is a block diagram illustrating components of a promotion system that operates in accordance with still another embodiment of the invention.

### DETAILED DESCRIPTION

Sheets of paper, such as paper used in conventional office environments for photocopying, computer printing and typing, are typically packaged in reams, with each ream containing 500 sheets of paper. Each ream is wrapped in a paper ream wrap, and the wrapped reams are then packed in cartons. The process is typically used for cutsize paper, having dimensions such as 8.5 inches by 11 inches, 8.5 inches by 14 inches and 11 by 17 inches. Larger sheets of paper (folio paper) having lengths of over 374 inches are typically placed directly on a skid and wrapped with a skid wrap, such as a plastic stretch wrap, or packed in a carton. Paper is also wound on a core to form a paper roll, which is wrapped in a paper roll wrap.

Conventional ream wraps and cartons are emblazoned with the name of the paper manufacturer, a practice referred to in the industry as “mill branding.” Accordingly, the purchasers of the paper can easily identify the source of the paper. In another conventional arrangement, paper manufacturers print the name of the purchaser on the ream wrap and the carton, a practice referred to in the industry as “private label marking.” Paper manufacturers may be reluctant to provide this service because the purchaser's name displaces the manufacturer's name and reduces the manufacturer's visibility in the marketplace. Accordingly, some manufacturers compensate for this drawback by requiring the purchasers to commit to buying a certain quantity of paper.

Aspects of the present invention are directed to a method and system for providing promotional materials, such as advertisements and/or coupons, on or within the packaging for paper products. In one embodiment of the invention, a computer system coordinates the manufacture and delivery to a purchaser of paper products wrapped with a wrapping material having an advertisement or coupon relating to a third party. The computer system can also coordinate the disbursement of a first remuneration from the purchaser for the paper and a second remuneration from the third party or advertiser for the advertisement and/or coupon.

The following description provides specific details for a thorough understanding of, and enabling description for, embodiments of the invention. However, one skilled in the art will understand that the invention may be practiced without these details. In other instances, well-known structures and functions have not been shown or described in detail to avoid unnecessarily obscuring the description of the embodiments of the invention. In general, alternatives and alternate embodiments described in this application are substantially similar to previously described embodiments, and common elements and acts or steps are identified by the same reference numbers. Only significant differences in construction or operation are described in detail.

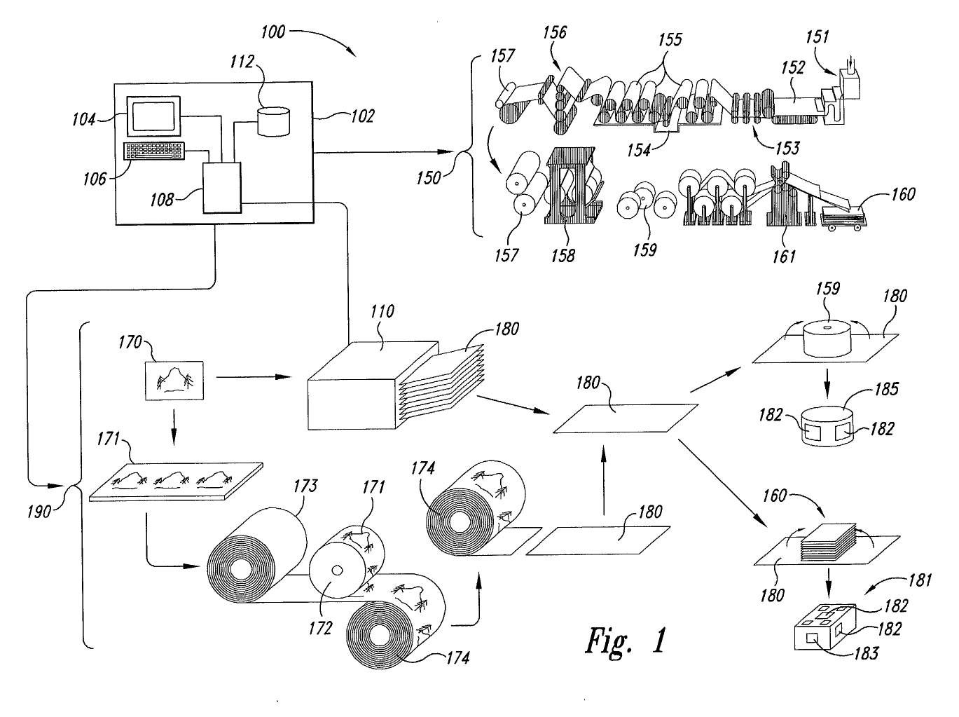

FIG. 1 and the following discussion provide a brief, general description of a suitable manufacturing and computing environment in which the invention can be implemented. In other embodiments, at least some of the steps taken in the computing environment can also be completed outside the computing-based environment using non-computer based process steps. When the invention is carried out in a computer environment, the embodiments of the invention will be described in the general context of computer-executable instructions on computer-readable media, for example, routines executed by a general-purpose computer, such as a personal computer. Those skilled in the relevant art will appreciate that the invention can be practiced with other computer system configurations, including Internet appliances, hand-held devices, mobile phones, multiprocessor systems, multiprocessor-based, or programmable consumer electronics, network PCs, mini-computers, mainframe computers, and the like. The invention can be embodied in a specific-purpose computer or data processor that is specifically programmed, configured or constructed to perform one or more of the computer-executable instructions explained in detail below. The invention can also be practiced in distributed computing environments where tasks or modules are performed by remote processing devices, which are linked through a communications network. In a distributed computing environment, program modules or sub-routines may be located in both local and remote memory storage devices. In general, while hardware platforms, such as terminals and controllers are described herein, aspects of the invention are equally applicable to nodes on the network having corresponding resource locators to identify such nodes.

Referring to FIG. 1, an embodiment of a system 100 includes a computer 102 having a monitor 104, a keyboard 106, and a processor 108. The computer 102 can be coupled to a database 112 stored on a computer-readable medium, with the database 112 storing information such as image files for printing on packaging materials for paper products (hereinafter “paper packaging materials”). The database 112 can also share information related to coordinating the production, packaging and distribution of paper products. Alternatively, the information can be stored in any other accessible location, such as the memory of the processor 108 or on a transportable computer-readable medium (not shown).

The computer 102 can be operatively coupled to a paper production line 150 and an enclosure production and process line 190. Accordingly, the computer 102 can coordinate the manufacture of the paper product, disposing promotional material on or in an enclosure for the paper product, enclosing the paper product, delivering the paper product, and tracking remuneration for the paper product and the promotional material. In one embodiment, the computer 102 can include one or more linked computing platforms, all under the control of a paper product manufacturer. Alternatively, the processes performed by the computer 102 can be distributed, with some operations performed by system components under the control of the paper product manufacturer, and others performed by system components controlled by a graphic arts producer, an enclosure manufacturer, the third-party advertiser, and/or intermediate parties.

In any of the foregoing embodiments, the paper production activities under the control and/or coordination of the computer 102 can include transferring pulp 152 from a headbox 151 to a press section 153, then to a sizing tub 154 and to downstream drying rolls 155. The paper is then passed through a calender stack 156 to form a large paper roll 157. The large paper roll 157 can be transferred to a slitter 158 to produce slit rolls 159. In one embodiment, the slit rolls 159 can be packaged for delivery to a purchaser. Alternatively, the slit rolls 159 can be passed through a sheet cutter 161 to produce an unbound stack of cut paper sheets 160. The paper sheets 160 (which include cutsize paper or folio paper) can then be packaged for delivery to the purchaser.

The enclosure production activities under the control and/or coordination of the computer 102 can include forming a design 170 for promotional material, for example, using a computer-based graphics routine. The design 170 can be generated on the computer 102, or generated on a different platform and transferred to the computer 102, for example, over the Internet. In one embodiment, the design 170 can be a computer-based image and can be transferred directly to a computer printer 110 to produce wrappers 180 for wrapping the paper product (e.g., the paper sheets 160 or the slit rolls 159). Alternatively, the design 170 can be transferred to a print plate 171 which can be mounted circumferentially about a printer roll 172. The printer roll can print the design 170 on a roll of blank wrapper paper 173 to form a printed wrapper roll 174. The wrapper 180 can then be cut from the wrapper roll 174 and sized to wrap the slit rolls 159 or the paper sheets 160. When the wrapper 180 encloses a slit roll 159, the resulting product is a wrapped roll 185. When the wrapper 180 encloses a ream of the paper sheets 160, the resulting product is a packaged ream 181.

In any of the foregoing embodiments, the wrapper 180 can have an outwardly facing surface with promotional material 182 (promoting goods and/or services of the third-party advertiser), and a print label 183 (identifying the type of paper product enclosed by the wrapper 180). The promotional material 182 can include an advertisement or a redeemable coupon. Alternatively, the promotional material 182 (advertisement or redeemable coupon) can be enclosed along with the paper product inside the wrapper 180 or other enclosure. In still a further alternate embodiment, the promotional material 182 can be disposed on the enclosure after the paper product is disposed within the enclosure.

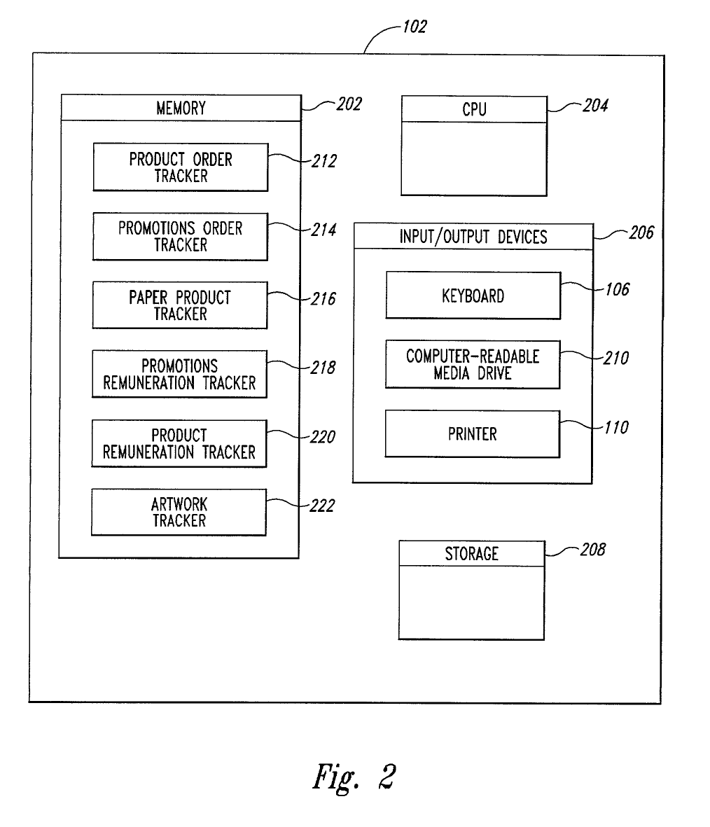

FIG. 2 is a schematic block diagram illustrating in further detail components of an embodiment of the computer 102 that automatically coordinates the production of paper products disposed in an enclosure bearing promotional materials. In one aspect of this embodiment, the computer 102 can include a memory 202, a CPU 204, input/output devices 206, and a storage device 208. The memory 202 can include software or other computer instructions for implementing a method in accordance with an embodiment of the invention. For example, the software can include a product order tracker 212 for tracking orders for paper products, a promotions order tracker 214 for tracking orders for promotional material on enclosures for the paper product, and a paper product tracker 216 for tracking the production and delivery of the paper product. The software can further include a promotions remuneration tracker 218 for tracking remuneration resulting from the promotional material, a product remuneration tracker 220 for tracking remuneration for the paper product, and an art work tracker 220 for tracking the art work defining the promotional material. In a further aspect of this embodiment, the software can include a database program, such as Microsoft Access. In other embodiments, the software can have other configurations.

The input output devices 206 can include the printer 110, the keyboard 106, and a computer-readable media drive 210. The computer-readable media drive 210 can read computer-readable media having the software for any of the trackers 212-222 described above. The software can also be accessible from the memory 202, as described above. Any of the information required by or generated by the foregoing software can be stored on the storage device 208, for example in a database.

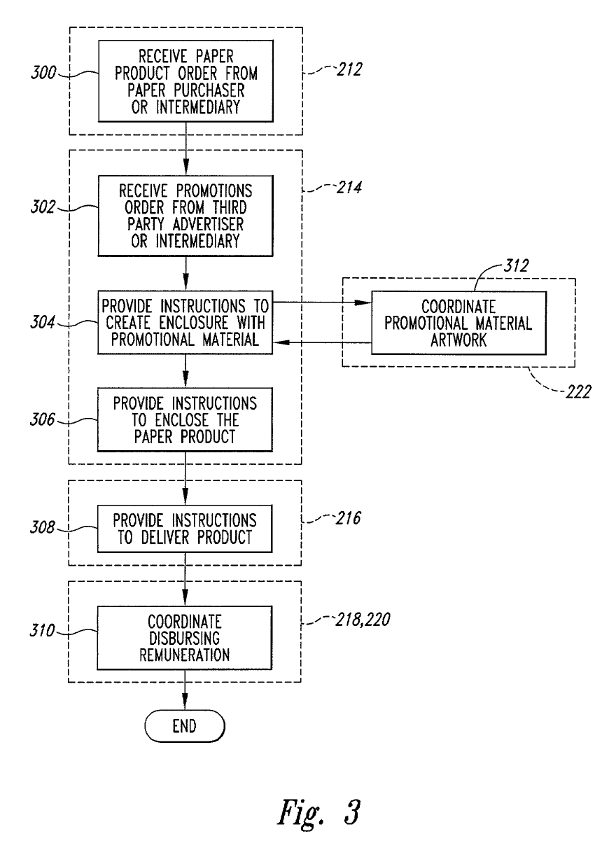

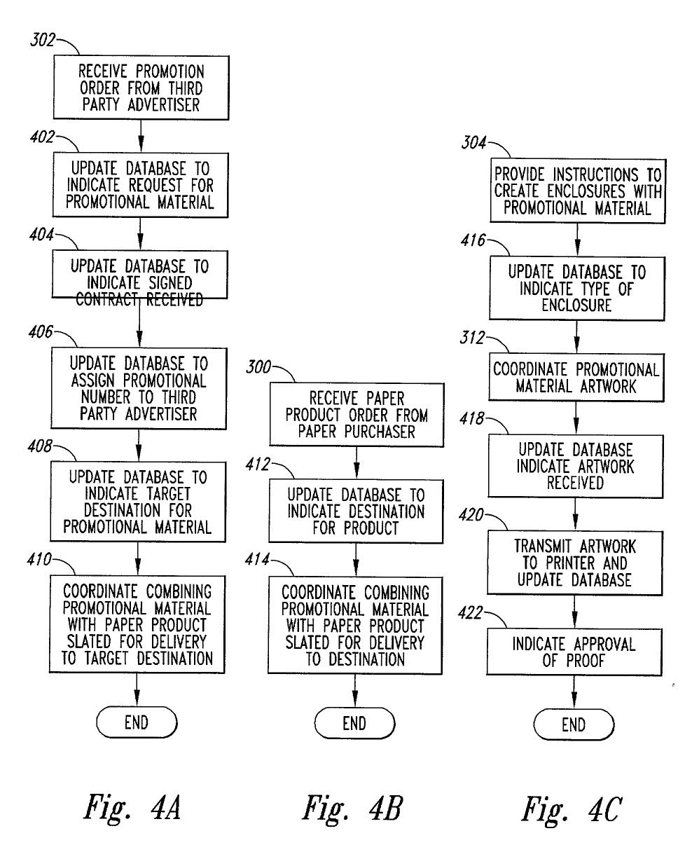

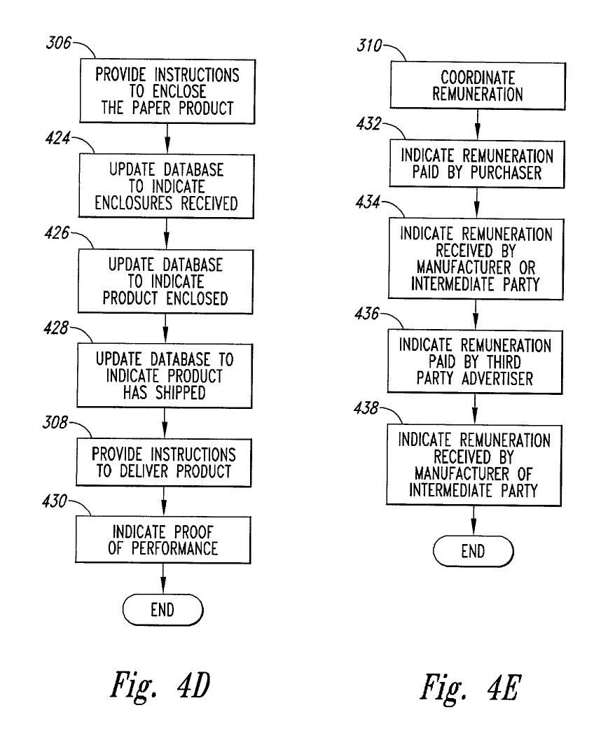

FIG. 3 is a flow diagram illustrating generally the processes performed by components of the computer 102 described above, and FIGS. 4A-E illustrate further details of these processes. Beginning with FIG. 3, the product order tracker 212 can receive a paper product order from a purchaser of paper products (step 300), or an intermediary acting on behalf of the paper purchaser. The promotions order tracker 214 can receive a promotions order from a third-party advertiser (step 302), or an intermediary acting on behalf of the third-party advertiser. The promotions order tracker 214 can then provide instructions to create an enclosure with the promotional material (step 304). These instructions can be coordinated with the artwork tracker 222 (steps 304 and 312). The promotions order tracker 214 can then provide instructions to enclose the paper product with the enclosure (step 306).

The paper product tracker 216 can provide instructions to deliver the paper product in step 308. The remuneration trackers 218, 220 can coordinate disbursing remuneration for the paper product itself and for the promotional material appearing on the enclosure for the paper product (step 310). In one embodiment, the remuneration for both the paper product itself and for the promotional material appearing on the enclosure for the paper product can accrue to the benefit of the paper manufacturer, and in other embodiments, the remuneration can be distributed, as described in greater detail below.

Turning now to FIG. 4A, the process of receiving a promotions order from a third-party advertiser (step 302) can include updating a database to indicate that the request for the promotional material has been received (step 402). The process can further include updating the database to indicate receipt of a signed contract containing the terms of an agreement with the third-party advertiser for production and distribution of the promotional materials (step 404). A promotion number can then be assigned for each item of promotional material selected by the third-party advertiser (step 406). The process can still further include updating the database to indicate a target destination for the promotional material solicited by the third-party advertiser (step 408). For example, if the promotional material is intended for a particular geographical market, the database can indicate the target geographical market. Alternatively, if the promotional material is intended for delivery to a particular paper product purchaser, the database can be updated to indicate the identity of the purchaser. In either embodiment, the process can include coordinating bringing the paper product slated for delivery to the target destination together with the enclosure bearing the promotional material selected for that paper product and that destination (step 410).

As shown in FIG. 4B, the process of receiving a paper product order from a paper purchaser (step 300) can include updating a database to indicate the destination for the product, as well as other particulars of the purchase (step 412). In step 414, the process can further include combining the paper product with the enclosure bearing the promotional material and slated for delivery to the target destination, in conjunction with step 410 discussed above with reference to FIG. 4A.

Turning now to FIG. 4C, the process of providing instructions to create an enclosure with promotional material (step 304) can include updating a database to indicate the type of enclosure on or in which the promotional material will appear (step 416). Coordinating the promotional material artwork (step 312) can include updating a database to indicate that the artwork is received (step 418). The process can further include transmitting the artwork to a printer and updating the database accordingly (step 420), and indicating approval by the third-party advertiser of a proof of the artwork (step 422).

Referring now to FIG. 4D, the process of providing instructions to enclose the paper product (step 306) can include updating a database to indicate that the enclosures, with the promotional material, have been received (step 424). The database can be updated to indicate that the product has been successfully enclosed in the enclosure (step 426). Providing instructions to deliver the packaged product (step 308) can include updating the database to indicate that the product has been shipped (step 428), and updating the database and/or apprising the third-party advertiser of proof of performance (step 430). For example, proof of performance can include successful delivery of the packaged paper product to the paper product purchaser.

In FIG. 4E, the process of coordinating remuneration (step 310) can include indicating remuneration paid by the purchaser of the paper product (step 432). The process can further include indicating that the remuneration paid by the purchaser for the paper product is received by the manufacturer or by an intermediate party (step 434). Similarly, the process can include indicating remuneration paid by the third-party advertiser (step 436) and received by the paper product manufacturer or an intermediate party (step 438).

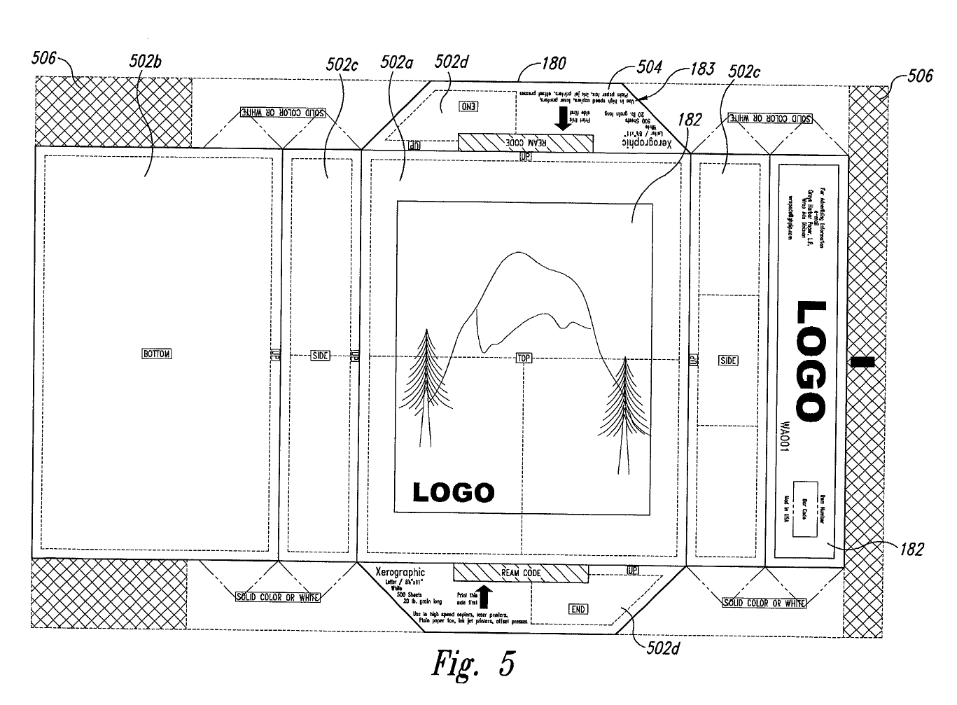

FIG. 5 illustrates an embodiment of an enclosure or wrapper 180 configured to wrap a ream of paper. The wrapper 180 is shown in its unfolded state to illustrate a top panel 502a having the promotional material 182. The wrapper 180 can also include a bottom panel 502b, side panels 502c and end panels 502d, each of which can include promotional material promoting the same or a different third-party advertiser. Product identifying information 183 can also be positioned on the end panels 502d. Cross-hatched areas 506 are generally obscured once the wrapper 180 is positioned around the ream of paper.

The promotional material 182 can have any of a wide variety of suitable formats. In one embodiment, all the promotional material 182 on a single wrapper 180 can promote a single third-party advertiser, or alternatively, different items of promotional material 182 on a single wrapper 180 can promote different third-party advertisers. In a further aspect of this embodiment, the different promotional material 182 can be related. For example, different promotional material 182 can promote different (but non-competitive) products or services in a similar industry. In one specific example, one item of promotional material 182 can promote a particular Internet company, and other items of promotional material 182 on the same wrapper 180 can promote other companies that advertise on the Internet company's web pages. Alternatively, the different promotional material 182 can be unrelated.

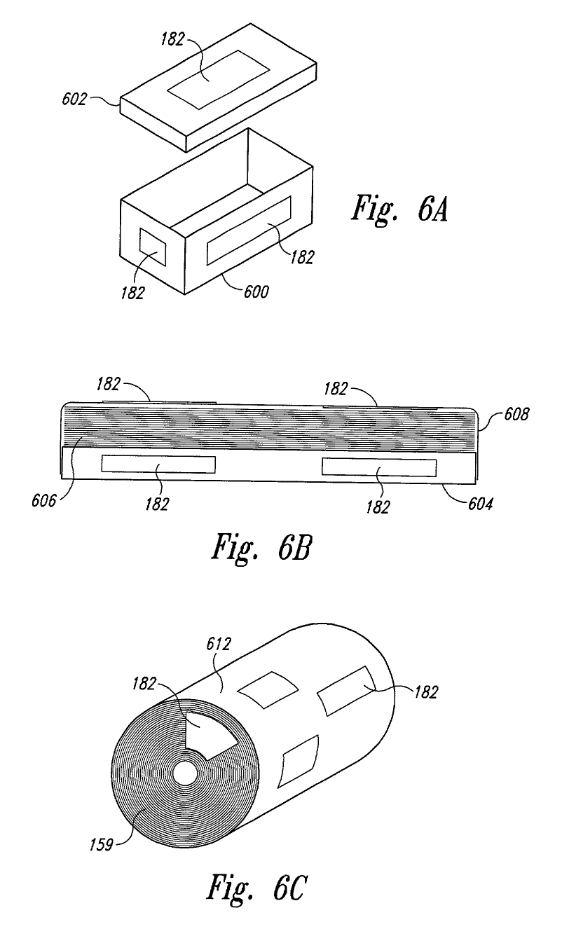

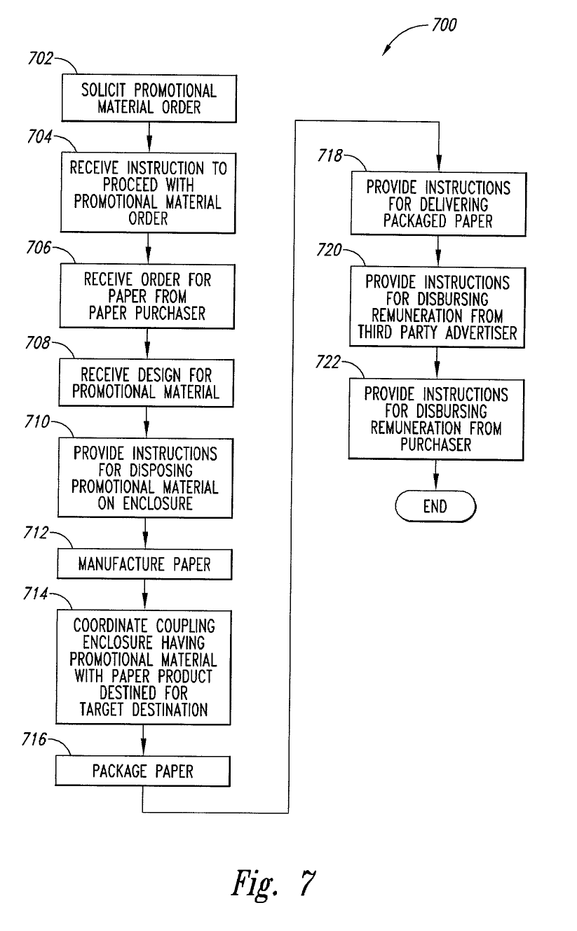

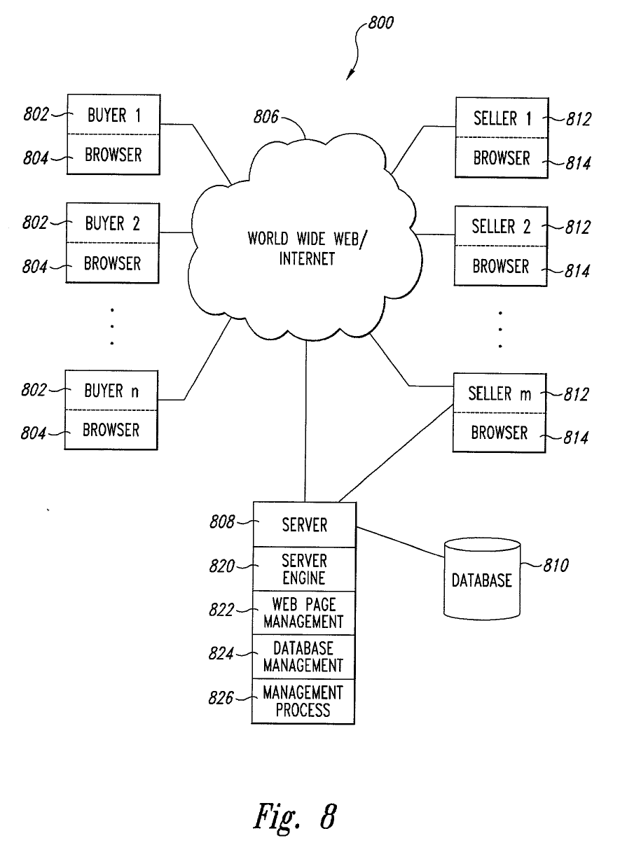

In other embodiments, the promotional material 182 (such as advertisement or coupons) can be placed on other enclosures. For example, FIG. 6A is an isometric view of a carton 600 for containing wrapped reams of paper. The carton 600 can include a lid 602, with the lid 602 and/or the carton 600 including advertisements or other promotional materials 182. An advantage of advertising on the carton 600 is that the carton is often not discarded after it is emptied of the paper products, but is instead used in offices or homes for storage. Accordingly, the promotional material 182 on the carton 600 can remain exposed to potential customers for an extended period of time.

FIG. 6B is a side-elevation view of a skid 604 supporting sheets of folio paper 606 which are wrapped with a folio wrap 608. In one embodiment, the skid 604 and/or the folio wrap 608 can include promotional material 182, such as advertisement or coupons. Alternatively (for example, when the folio wrap 608 is a clear plastic), the promotional material 182 can be placed either directly on the external surface of folio wrap 608, or face up on the internal surface of the folio wrap 608, or on sheets of paper disposed between the uppermost sheet of folio paper 606 and the folio wrap 608.

FIG. 6C is an isometric view of a paper roll 610 wrapped with a roll wrap 612 having advertisements or other promotional materials 182. If the end of the paper roll 159 is exposed, the promotional material 182 can be placed on a separate sheet attached directly to the paper roll 159. The promotional materials 182 can have a layout or format generally similar to those used for other print media materials, such as magazine advertisements or coupons. Any of the paper packaging materials described above with reference to FIGS. 6A-6C can also include identifying labels 183, described above with reference to FIG. 1.

FIG. 7 is a flow diagram of a representative promotion process 700 in accordance with an embodiment of the invention. In one aspect of this embodiment, many of the process steps can be performed automatically by the components of the system 100 described above with reference to FIG. 1. Alternatively, some or all of the process steps can be performed without one or more of the components of the system 100.

Beginning with step 702, the paper manufacturer solicits an order for an advertisement or other promotion. For example, the paper manufacturer can solicit an order directly from an entity (such as an individual or a business firm) wishing to promote its products and/or services. Alternatively, the paper manufacturer and/or the entity can employ an agent or other party to solicit and/or accept an order for an advertisement, as described below. In either embodiment, the promotional material can include an advertisement or a redeemable coupon. In step 704, the manufacturer receives instructions to proceed with the promotional material order. In step 706, the manufacturer receives an order for a paper product from a paper purchaser. In step 708, the manufacturer receives a design for the promotional material. In one aspect of this embodiment, the design can be created by the third-party advertiser or by an advertising agency and transmitted to the manufacturer. Alternatively, the manufacturer can create the design.

In step 710, instructions provided are provided for disposing the promotional material design on or in an enclosure for paper products, paper packaging, for example, using the system 100 described above with reference to FIG. 1. As described above, the paper packaging material can include an enclosure such as a paper ream wrap, a carton, a skid, a skid wrap, and/or a roll wrap. In step 712 the paper manufacturer manufactures paper, such as cutsize paper or folio paper. In step 714, the manufacturer can coordinate bringing together an enclosure having promotional material targeted for a particular destination with a paper product targeted for the same destination. In step 716, the paper is packaged with the paper packaging material, and step 718, instructions are provided to deliver the packaged paper. In one aspect of this embodiment, the packaged paper can be delivered directly to an end user. Alternatively, the packaged paper can be delivered to a paper distributor or another party that transfers the paper to an end user. In either embodiment, the manufacturer can provide instructions for disbursing a first remuneration from the third-party advertiser for the advertisement (step 720) and a second remuneration for the paper itself (step 722). The remuneration for the advertisement can be determined based on factors such as the size and complexity of the advertisement, the placement of the advertisement on the packaging material, and the number of advertisements placed.

In one embodiment, steps 702-722 can be performed entirely by the paper manufacturer. Alternatively, one or more of the steps can be performed by other parties. For example, an advertising agency can solicit advertisements from an advertiser on behalf of the paper manufacturer, a printer can print the advertisements on the paper packaging materials, and/or a separate carrier can deliver the paper. In any of these embodiments, the party ultimately financially responsible for purchasing the advertisement is different than the party ultimately financially responsible for purchasing the enclosed paper product. Accordingly, this arrangement is distinct from both the mill branding and the private label arrangements described above.

One feature of an embodiment of the system and method described above with reference to FIGS. 1-7 is that advertisers can promote products and/or services by advertising on materials used to package or enclose paper products. An advantage of this feature is that the advertisements can be visible to prospective consumers of the advertised products and services for an extended period of time. For example, paper ream wraps typically remain next to an office printer or a computer printer for the length of time it takes to use up the paper. During this time, prospective customers are repeatedly exposed to the advertisement.

Another advantage of an embodiment of the promotion system and method described above with reference to FIGS. 1-7 is that the advertisements on the paper packaging materials can be specifically targeted to those paper purchasers most likely to purchase the advertised goods or services. For example, paper wrapped with packaging material having advertisements for office supplies can be directed to offices and schools. Advertisements for Internet-based companies can be directed to computer users and operators. Advertisements for financial services and/or journals can be directed to firms in the financial sector. Advertisements can also be directed to selected geographical areas. In other embodiments, the method can include other targeting arrangements.

Still another advantage of an embodiment of the system and method described above with reference to FIGS. 1-7 is that the end user may pay less for paper enclosed in a wrapper or carton bearing promotional materials than he would pay for conventionally enclosed paper. Alternatively, the paper manufacturer can realize a greater profit than is available with conventionally enclosed paper. Either result (or both results) are possible because the advertiser contributes to the cost of producing the enclosed paper.

Yet another advantage of an embodiment of the system and method described above with reference to FIGS. 1-7 is that the promotional material 182 can be less costly than conventional advertisements, such as television, radio and magazine advertisements. Accordingly, advertisers can more efficiently promote their products.

FIG. 8 and the following discussion provide a brief, general description of a suitable computing environment in which another embodiment of the invention can be implemented. In one aspect of this embodiment, a system 800 includes one or more buyer computers 802, each of which includes a browser program module 804 that permits the computer to access and exchange data with the Internet, including web sites within a World Wide Web (“Web”) portion 806 of the Internet. The buyer computers 802 may include one or more central processing units or other logic processing circuitry, memory, input devices (e.g., keyboards and pointing devices), output devices (e.g., display devices and printers), and storage devices (e.g., fixed, floppy and optical disk drives, magnetic cassettes, flash memory cards, digital video disks (DVDs), Bernoulli cartridges, RAMs, ROMs, smart cards, etc.), all well known but not shown in FIG. 8. The buyer computers 802 may also include other program modules, such as an operating system, one or more application programs (e.g., word processing or spreadsheet applications) and the like.

A server computer 808 coupled to the Web 806, performs some of the operations described below. A database 810 coupled to the server computer 808, stores much of the data exchanged between the buyer computers 802, the server computer 808 and one or more seller computers 812, as described below. Each seller computer 812 is similar to the buyer computers 802, and includes a browser 814 to permit the seller computer 812 to access and exchange information via the Web 806. The seller computer 812 can also be connected directly to the server computer 808.

The server computer 808 includes a server engine 820, a web page management component 822, a database management component 824, a management process component 826, as well as other components not shown in FIG. 8. The server engine 820, the web page management component 822, the database management component 824 and the management process component 826 operate together to unite buyers with sellers over the Internet 806.

In one embodiment, the buyers of paper products access the buyer computers 802 and place orders with the server 808 via the Web 806 for paper having certain specifications. The orders can be transmitted to sellers (such as manufacturers) of paper goods via the Web 806 and the seller computers 812 in one embodiment. Alternatively, the orders can be transmitted only to the server 808, and the server 808 can be controlled by a paper distributor. The orders can be filled by the distributor without transmitting the orders directly to the paper sellers. The distributor can then maintain a stock of paper by periodically contacting the sellers and having the stock replenished. Accordingly, the transaction between the paper sellers and the paper buyers is “blind”, with neither the sellers nor the buyers knowing the identity of the other. Alternatively, the distributor can route specific orders to the seller so that the seller can provide to the buyer paper having advertisements specifically targeted to that buyer, as described above.

From the foregoing it will be appreciated that, although specific embodiments of the invention have been described herein for purposes of illustration, various modifications may be made without deviating from the spirit and scope of the invention.

1. A computer system for processing a paper product, comprising:
a product order tracker configured to receive a paper product order from a paper purchaser to purchase a paper product that is produced by a paper manufacturer, the paper product including a roll of paper or a plurality of unbound, stacked paper sheets;
a promotions order tracker configured to receive a promotional material order from a third-party advertiser to place promotional material on an enclosure for the paper product or in an enclosure for the paper product; and
a paper product tracker configured to provide instructions for creating an enclosure for the paper product, the enclosure having or enclosing the promotional material of the received promotional material order, the paper product tracker further being configured to provide instructions to enclose the paper product of the received order with the created enclosure, wherein the paper manufacturer, the paper purchaser, and the third-party advertiser are different entities and the third-party advertiser pays to have the promotional material placed on or enclosed by the enclosure of the paper product.

2. The computer system of claim 1, further comprising a remuneration tracker configured to track remuneration paid by the third-party advertiser for the promotional material.

3. The computer system of claim 1, further comprising an artwork tracker configured to provide instructions for creating a fixed medium that includes the promotional material.

4. The computer system of claim 1 wherein the promotions order tracker is configured to coordinate enclosing the paper product with a particular enclosure based on the content of the promotional material, the identity of the paper purchaser, and/or a location to which the paper product is to be delivered.

5. The computer system of claim 1 wherein the promotional material order is a first promotional material order for first promotional material and the third-party advertiser is a first third-party advertiser, and wherein the promotions order tracker is configured to receive a second promotional material order from a second third-party advertiser to place second promotional material on the enclosure.

6. The computer system of claim 1 wherein the product order tracker is configured to receive a paper product order for unbound, stacked sheets of paper and/or a roll of paper.

7. The computer system of claim 1 wherein the promotions order tracker is configured to receive an order for an advertisement placed on a wrapper configured to enclose unbound stacked sheets of paper.

8. The computer system of claim 1 wherein the promotions order tracker is configured to receive an order for an advertisement placed on a wrapper configured to enclose a roll of paper.

9. The computer system of claim 1 wherein the promotions order tracker is configured to receive an order for an advertisement placed on a box configured to enclose the paper product.

10. The computer system of claim 1 wherein the promotions order tracker is configured to receive an order for a coupon placed on or enclosed by the enclosure.

11. A method in a computer system for preparing a paper product, the method comprising:
receiving a paper product order from a paper purchaser to purchase a paper product that is produced by a paper manufacturer;
receiving a promotions order from a third-party advertiser to place promotional material on or in an enclosure of a paper product;
providing instructions to create an enclosure for the paper product, the enclosure having or enclosing the promotional material of the received promotions order, and providing instructions to enclose the paper product of the received order with the created enclosure; and
providing instructions to deliver the paper product enclosed with the created enclosure to a delivery location, wherein the paper manufacturer, the paper purchaser, and the third-party advertiser are different entities and the third-party advertiser pays to have the promotional material placed on or enclosed by the enclosure of the paper product.

12. The method of claim 11 wherein receiving a paper product order includes receiving the order from an intermediate party, with the intermediate party receiving the order from the paper purchaser.

13. The method of claim 11 wherein receiving a promotions order includes receiving the order from an intermediate party, with the intermediate party receiving the order from the third-party advertiser.

14. The method of claim 11, further comprising tracking receipt of remuneration from the third-party advertiser for the promotional material.

15. The method of claim 11, further comprising tracking receipt of remuneration from the third-party advertiser to an intermediate party for the promotional material.

16. The method of claim 11, further comprising tracking receipt of remuneration from the paper purchaser for the paper product.

17. The method of claim 11, further comprising tracking receipt of remuneration from the paper purchaser to an intermediate party for the paper product.

18. A computer system for tracking a transaction among a paper manufacturer, a paper purchaser, and a third-party advertiser, the computer system comprising:
a paper order tracker configured to track an order from the paper purchaser for purchase of a plurality of unbound, stacked paper sheets produced by the paper manufacturer;
an advertisement order tracker configured to track an order from the third-party advertiser for an advertisement placed on a wrapper configured to at least partially enclose and the protect the plurality of unbound, stacked paper sheets;
a first remuneration tracker configured to track payment of a first remuneration from the paper purchaser for purchase of the paper; and
a second remuneration tracker configured to track payment of a second remuneration from the third-party advertiser for the advertisement.

19. The computer system of claim 18 wherein the advertisement order tracker is configured to instruct an intermediate party to place the advertisement on the wrapper.

20. The computer system of claim 18 wherein the first remuneration tracker is configured to track the receipt of the first remuneration from the paper purchaser for purchase of the paper.

21. The computer system of claim 18 wherein the second remuneration tracker is configured to track receipt of the second remuneration from the third-party advertiser for the advertisement.

22. A computer system for tracking a transaction among a paper product manufacturer, a paper product purchaser, and a third-party advertiser, the computer system comprising:
an order tracker capable of tracking an order from the third-party advertiser for promotional material placed on or enclosed by an enclosure configured to at least partially enclose and protect a paper product, the paper product including a plurality of unbound, stacked paper sheets produced by the paper product manufacturer or a roll of paper produced by the paper product manufacturer, the enclosure including a wrap or a carton configured to at least partially surround the paper product; and
a remuneration tracker capable of tracking remuneration paid by the third-party advertiser for the promotional material and updating a database to indicate receipt of the remuneration.

23. The computer system of claim 22 wherein the remuneration tracker is configured to track remuneration received from the third-party advertiser for the promotional material.

24. The computer system of claim 22 wherein the order tracker is configured to track an order for an advertisement placed on an external surface of a wrapper configured to enclose a ream of paper.

25. The computer system of claim 22 wherein the order tracker is configured to track an order for a coupon disposed on or in the enclosure.

26. A computer-readable medium, the contents of which perform a method for tracking a transaction among a paper product manufacturer, a paper product purchaser, and a third-party advertiser, the method comprising:
receiving an indication of an order from the third-party advertiser for promotional material placed on or enclosed by an enclosure configured to at least partially enclose and the protect a paper product, the paper product including a plurality of unbound, stacked paper sheets produced by the paper product manufacturer, or a roll of paper produced by the paper product manufacturer, the enclosure including a wrap or a carton configured to at least partially surround the paper product;
updating a database to indicate receipt of the order;
receiving an indication that remuneration has been paid by the third-party advertiser for the promotional material; and
updating the database to indicate payment of the remuneration.

27. The computer-readable medium of claim 26 wherein the method further comprises:
receiving an indication that remuneration has been received from the third-party advertiser for the promotional material; and
updating the database to indicate receipt of the remuneration.

28. The computer-readable medium of claim 26 wherein receiving an indication of an order includes receiving an indication of an order for an advertisement disposed on an external surface of a ream wrapper.

29. The computer-readable medium of claim 26 wherein the method further comprises providing instructions to create an enclosure for the paper product, the enclosure having or enclosing the promotional material of the received promotions order, and providing instructions to enclose the paper product of the received order with the created enclosure.

30. The computer-readable medium of claim 26 wherein the method further comprises providing instructions to deliver the paper product enclosed with the created enclosure to a delivery location.

31. A method for selling paper products over a computer network, comprising:
receiving an order for a paper product from a purchaser over a computer network, the paper product including unbound stacked sheets of paper or a roll of paper; and
filling the order with a paper product manufactured by a paper product manufacturer, the paper product being at least partially enclosed by a protective enclosure, the enclosure having or enclosing promotional material configured to identify and/or promote goods and/or services of a third party different from the manufacturer and different from the purchaser, wherein an identity of the purchaser is withheld from the paper product manufacturer and an identity of the paper product manufacturer is withheld from the purchaser.

32. The method of claim 31 wherein filling the order includes providing a ream of paper wrapped with a ream wrap having an advertisement promoting goods and/or services of the third party.

33. The method of claim 31 wherein filling the order includes providing a coupon disposed on or in the enclosure.

34. A method for providing paper products with promotional materials, comprising:
receiving an order from a purchaser for a paper product, the paper product including unbound stacked sheets of paper or a roll of paper;
manufacturing the paper product;
providing instructions for disposing promotional material on or in an enclosure configured to at least partially enclose and protect the paper product, the promotional material being requested by a third party;
providing instructions for disposing the paper product within the enclosure;
providing instructions for disbursing a first remuneration from the purchaser; and
providing instructions for disbursing a second remuneration from the third-party advertiser for the promotional material.

35. The method of claim 34, further comprising receiving the first remuneration from the purchaser.

36. The method of claim 34, further comprising receiving the second remuneration from the third-party advertiser.

37. The method of claim 34, further comprising disposing the promotional material on the enclosure before disposing the paper product within the enclosure.

38. The method of claim 34, further comprising disposing the promotional material on the enclosure after disposing the paper product within the enclosure.

39. The method of claim 34, further comprising receiving an order from the third-party advertiser for the promotional material.

40. The method of claim 34 wherein providing instructions for disposing promotional material includes providing instructions for printing an advertisement on an external surface of the enclosure.

41. The method of claim 34 wherein providing instructions for disposing promotional material includes providing instructions for providing coupons configured to be disposed within the enclosure.

42. The method of claim 34 wherein providing instructions for disposing promotional material on or in an enclosure includes providing instructions for disposing promotional material on a ream wrap configured to enclose a ream of paper.

43. The method of claim 34 wherein providing instructions for disposing promotional material on or in an enclosure includes providing instructions for disposing promotional material on a roll wrap configured to enclose a roll of paper.

44. The method of claim 34 wherein providing instructions for disposing promotional material on or in an enclosure includes providing instructions for disposing promotional material on a skid wrap configured to enclose a stack of unbound paper on a skid.

45. The method of claim 34 wherein providing instructions for disposing promotional material on or in an enclosure includes providing instructions for disposing promotional material on a carton configured to contain the paper product.

46. The method of claim 34 wherein providing instructions for disbursing a first remuneration from the purchaser includes directing the first remuneration to be paid to an intermediate party.

47. The method of claim 34 wherein providing instructions for disbursing a second remuneration from the third-party advertiser for the promotional material includes directing the second remuneration to be paid to an intermediate party.

48. The method of claim 34, further comprising instructing another entity to dispose the promotional material on the enclosure.

49. A method for providing paper products with promotional materials, comprising:
receiving an order from a purchaser for a ream of paper;
receiving an order from a third-party advertiser for an advertisement placed on a wrapper configured to at least partially enclose and protect the ream of paper;
manufacturing the ream of paper;
wrapping the ream of paper with the wrapper, the wrapper having the advertisement and at least partially enclosing and protecting the ream of paper;
receiving a first remuneration from the purchaser for the ream of paper; and
receiving a second remuneration from the third-party advertiser for the advertisement on the wrapper.

50. The method of claim 49, further comprising instructing an intermediate party to place the advertisement on the wrapper.

51. The method of claim 49, further comprising selecting the wrapper for the ream based on the content of the advertisement, the identity of the purchaser, and/or a location to which the ream is to be delivered.

52. A package of paper products, comprising:
a plurality of stacked, unbound paper sheets produced by a paper sheet manufacturer and purchased by a paper purchaser;
a wrapper disposed around the plurality of paper sheets, the wrapper being positioned to at least partially enclose and protect the plurality of paper sheets; and
promotional material disposed on the wrapper, the promotional material having a content configured to identify and/or promote goods and/or services of a third-party advertiser different from the manufacturer and different from the paper purchaser.

53. The package of claim 52 wherein the promotional material includes an advertisement.

54. The package of claim 52 wherein the third-party advertiser is a first third-party advertiser and the promotional material includes a first advertisement configured to identify and/or promote goods and/or services of the first third-party advertiser, and wherein the promotional material further includes a second advertisement configured to identify and/or promote goods and/or services of a second third-party advertiser.

55. The package of claim 52 wherein the promotional material includes a coupon.

56. The package of claim 52 wherein the plurality of stacked, unbound paper sheets includes a ream of paper.

57. A packaged roll of paper, comprising:
an elongated sheet of paper rolled upon itself to form a paper roll, the elongated sheet of paper being produced by a paper sheet manufacturer and purchased by a paper purchaser;
a wrapper disposed around the paper roll, the wrapper being positioned to at least partially enclose and protect the paper roll; and
promotional material disposed on the wrapper, the promotional material having a content configured to identify and/or promote goods and/or services of a third-party advertiser different from the manufacturer and different from the paper purchaser.

58. The packaged roll of claim 57 wherein the promotional material includes an advertisement.

59. The packaged roll of claim 57 wherein the third-party advertiser is a first third-party advertiser and the promotional material includes a first advertisement configured to identify and/or promote goods and/or services of the first third-party advertiser, and wherein the promotional material further includes a second advertisement configured to identify and/or promote goods and/or services of a second third-party advertiser.

60. The packaged roll of claim 57 wherein the promotional material includes a coupon.

61. A package of paper products, comprising:
a plurality of unbound paper sheets produced by a paper sheet manufacturer and purchased by a paper purchaser;
a carton in which the plurality of paper sheets is positioned, the carton at least partially enclosing and protecting the paper sheets; and
promotional material disposed on the carton, the promotional material having a content configured to identify and/or promote goods and/or services of a third-party advertiser different from the paper sheet manufacturer and the paper purchaser.

62. The package of claim 61 wherein the promotional material includes an advertisement.

63. The package of claim 61 wherein the third-party advertiser is a first third-party advertiser and the promotional material includes a first advertisement configured to identify and/or promote goods and/or services of the first third-party advertiser, and wherein the promotional material further includes a second advertisement configured to identify and/or promote goods and/or services of a second third-party advertiser.

64. The package of claim 61 wherein the promotional material includes a coupon.
